(19) United States
(12) Patent Application Publication
(10) Pub. No.: US 2018/0348965 A1
(43) Pub. Date: Dec. 6, 2018

(54) SOCIAL STREAM IN PROGRAMMING CONTENT

(71) Applicant: Google Inc., Mountain View, CA (US)

(72) Inventor: Zoltan Stekkelpak, Sunnyvale, CA (US)

(73) Assignee: Google Inc., Mountain View, CA (US)

(21) Appl. No.: 13/831,296

(22) Filed: Mar. 14, 2013

Related U.S. Application Data
(60) Provisional application No. 61/625,012, filed on Apr. 16, 2012.

(51) Int. Cl. G06F 3/0482

(52) U.S. Cl. CPC G06F 3/0482

(57) ABSTRACT

The subject matter of this specification can be implemented in, among other things, a method for integrating personal content items in existing programming content. The method includes a step for selecting one or more personal content items. The method also includes a step for converting the selected content items to a presentation format. The method also includes a step for providing the converted content items for integration with existing programming content.

### CROSS-REFERENCE TO RELATED APPLICATIONS

The present application claims the benefit of priority under 35 U.S.C § 119 from. U.S. Provisional Patent Application Ser. No. 61/623,012, filed on Apr. 16, 2012, the disclosure of which is hereby incorporated by reference in its entirety for all purposes.

### BACKGROUND

This instant specification relates to social content, in particular to integrating social content within programming content, for example television and radio programs.

People may turn to television and radio to get news, e.g., general news not specific to a particular viewer or listener. News and other programs on television and radio may deliver content in a structured way, providing programming content in an allotted time slot for a particular segment. For example, a news program may have time slots tor foreign, national polities, business, and celebrity sections of news coverage. On the other hand, people may tarn to their social networking source (e.g., a website on a desktop, laptop, or mobile device) to receive personal news or information (e.g., commentary or images from friends, family, or other social networks or circles of interest to a user). Thus, a consumer of news typically may go to multiple sources to obtain “general” and personal news or information.

### SUMMARY

The disclosed subject matter relates to a method for integrating personal content items with programming content. In one aspect, a method includes selecting one or more content items from a personal content stream. The method also includes converting the selected content items from a stream format into a presentation format. The method also includes providing the converted content stems for presentation by integration with existing programming content. Other aspects include corresponding systems, apparatus, and computer program products.

These and other aspects can include one or more of the following features. Selecting one or more content items from a personal content stream may include selecting various type of content items suitable for presentation from a personal content stream received from a social networking platform. Selecting one or more content items may also include selecting content items received at a certain lime for providing the content items for integration In existing programming content. Selecting one or mote content items may also include selecting content items being received from a particular scarce for delivery to a user.

Converting the selected content items to a presentation format may include converting one or more content items to an image, video, audio, or text format suitable for presentation. The conversion to a presentation format may also include: adding an animation to recite content items converted to an audio format.

The disclosed subject matter further relates to a non-transitory computer-readable medium. The computer-readable medium includes instructions that, when executed by a computer, cause the computer to implement a method for integrating social content Items in existing programming content. The instructions include code for receiving social content items. The instructions also include code for converting the social content items to a presentation format. The instructions also include code for providing the converted social content items for presentation within existing programming content.

The disclosed subject matter further relates to a system. The system may include a client content module and a personal content display module. The client content module may be configured to receive one or more social content items for integration within an existing program. The personal content display module may be configured to determine a current time slot for the existing program viewable by a user. The personal content display module may also be configured to determine if the current time slot is a time slot flagged for personal content. The personal content display module may also be configured to display at least a portion of the received one or more social content items where the current time slot is determined to be the time slot flagged for presenting personal content.

These and other embodiments may provide one or more of the following features. One advantage of integrating personal content in existing programming content is that a user may not have to go to multiple sources to consume different types of information. Another advantage is that a user may be able to make better use of their time by not receiving content that is not of interest to them (e.g., replacing advertisements with personal content). Also, the user experience may be enhanced by using a client device such as a smart television for personal content, for example because a television often has a larger screen or because the various user interactions are integrated on a single device.

The details of one or more implementations are set forth in the accompanying drawings and the description below. Other features and advantages will be apparent from the description and drawings, and from the claims.

### DESCRIPTION OF DRAWINGS

The features of the subject technology are set forth in the appended clauses. However, for purpose of explanation, several aspects of the disclosed subject matter are set forth in the following figures.

FIG. 1 is a schematic diagram that shows an example of a system for providing personal content on client devices.

FIG. 2 illustrates an example of the server and client device of FIG. 1 in more detail.

FIG. 3 is flow chart that shows an example of a process for providing personal content on client devices.

FIG. 4 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, some structures and components are shown in block diagram form in order to avoid obscuring the concepts of the subject technology.

This document describes systems and techniques that take news or oilier content from multiple sources and makes the content available on one platform. In some implementations, a method is provided for taking personal content (e.g., social, content for a user received from one or more social networking platforms) and delivering the personal content for integration within existing programming content to a user. For example, the content may be delivered to the user on a client device. Personal content may be converted to a presentation format for integration with programming content. For example text comments provided on a social networking platform may be converted to a television-friendly format, for example an audio plus animation format, and provided to a smart television to present personal news within a segment of an existing news program. As another example, a live streaming video received from a social platform may replace segments of an existing video on a computer screen (e.g., on a news provider's website providing news content). Personal content streams or items may be converted, filtered and/or buffered before integrating within an existing programming segment.

Personal, content items may include text, video, audio, images, albums of content, and/or personalized commercial content (e.g., advertisements, sales pitch, product or service infomercials, etc.). In implementations where personalized commercialized content is the content provided to replace existing programming content, advertisement revenue sharing may occur between the provider of the personalized commercialized content and the provider of the existing programming content (e.g., television or radio content, provider).

The source of personal content may be a social networking platform, a messaging server, a blog site, etc. Using the subject technology, a shared video may be played on a smart television screen, or an image slide show may be presented to a viewer of the smart television, within tar existing television news program. In some implementations, personal content presented to a user is interactive (e.g., the user can control, the presented content). For example, a smart television might provide a keyboard to control items on the screen e.g., jumping to the next item (skipping), repeating a previous one, giving a indicator to items that a user likes or providing comments for presented items. In some implementations, the user interaction with presented personal content is achieved by a local application installed on the client device.

Personal content may be integrated within existing programming concern in a “you” section—a section including one or more segments (or time slots) of an existing program dedicated for providing personal news (e.g., content received from a viewer's or listener's social stream). In some implementations, one or more segments of a news program are flagged for providing personal news, indicating that the flagged segments are to be replaced with personal content. For example, in a news program having segments for foreign, national, politics, business, and celebrity news, the celebrity section may be flagged as a personal news section. As such, the celebrity news segment, may be replaced with personal content items received by a client device presenting the news program. Existing content may be completely replaced with personal content (e.g., the whole screen will show personal content items) or may be partially replaced with personal content (e.g., ticker display or split-channel display of personal content as discussed in more details below).

A user of a device presenting programming content may select different topics, segments, and/or periods of time during which personal content may be integrated with existing programming content. With the user-selected topics, the system may identify the corresponding time slots from programming guides or other information provided by the programming content providers. In some implementations, the-user may select periods of time during which personal content may be integrated with existing programs.

For example, a “you” section may be defined by a user selecting certain programming segments from a list of time slots for existing programs to be reserved for providing personal news. In some implementations, a first of time, slots for existing programs and programming segments is created by accessing programming guides from television or radio program providers. In some implementations, a list of time slots for programs is determined by processing content data streams (e.g., television, or radio content) received from television or radio programming providers. A list of programming time slots can then be used to allow viewers to select segments for providing personal news. For example, a user of an network-connected television may choose from the list of programming time slots those segments of a program that are not of interest to the viewer. When a television, program reaches a segment that is not of interest to the user, the original television content may be replaced with personal news or other personal content items.

In same implementations, existing content is replaced with personal content, items in a more dynamic fashion. In some implementations, programming content is replaced with personal content upon the determination of a flag or signal in the received programming content. For example, a user may designate advertisement content should be replaced with personal news content. As such, streams of existing programming content, as they are received, may be processed to find a “start” flag designating the beginning of advertising content. Programming content from the “start” flag may then be replaced with personal news content until for example an “end” flag is reached in the exiting programming content stream—designating the end of advertising content. Replacing advertisement content with personal content may be more selective. For example, only certain types of advertisements (e.g., determined by a flag in the programming content) that are not of interest to a user may be replaced with personal content items while others may not be replaced, instead being delivered as received from the programming stream.

In some implementations, a personal content integration system determines user preferences based on user-authorized processing of past usage history (e.g., past television watching patterns, past search histories, click streams, places visited, etc.). In some implementations, the system may provide users an option, to opt in or opt out of this processing. For example, a past pattern where a user switches from a news channel when a celebrity news segment is being delivered may indicate a user's lack of interest in celebrity news. As another example, by processing past user search histories, the system may determine that the user does not have interest, for example in politics, and thus may replace the politics segment of a news program with personal news items. A user of the system may provide preferences that override system generated preferences, thereby providing control to the user for when personal content should replace existing content. A user may also set a preference that disables system generated preferences.

In some implementations, a personal content Integration system may determine that received personal content items are of a high priority and replace existing programming content irrespective of whether or not the existing programming content is at a spot that is designated for replacing content. High priority items may be those items that contain important personal news or comments (e.g., as determined by a flag or other indicator provided with the personal content item, or as determined by certain keywords in the text of the personal content items). As such, high priority personal content items may replace existing programming content at any point in the existing programming content. For example, as soon as a high priority social comment or news item is received, existing programming content may be immediately replaced with the high priority social comment or new item. Replacing existing programming content with high priority personal content may be system or user configurable or based on user preferences.

It may be desirable to convert personal content, e.g., received, from a social stream, to a suitable presentation format before delivering it to a television screen for viewing purposes. In some implementations, textual data received from a social stream is converted to audio data. Such audio data may be synchronized with an animated character to deliver a user's personal news as if spoken by the animated character. The animated character may be user-selected. For example, a user fond of a particular actor may configure his or her personal news to be delivered by an animation of that actor. In some implementations, this is achieved by converting text data from a social stream to voice data that is delivered by an animation resembling the actor thereby generating TV-like-experience content from data received from social streams.

In some implementations, received social stream data is converted to a text format, where required, and displayed in a ticker-like fashion on a portion of the screen (e.g., oh a bottom section). In a ticker implementation, social stream data may be displayed. In a continuous fashion (e.g., continuously displaying streaming social content in an information ribbon on the screen). A ticker of textual information from a social stream may be displayed on a particular channel, multiple channels or on all channels. For example, a ticker of personal news may be configured to be displayed on a news channel and not on other channels, for example movie or non-news program channels. Such preferences may be system or user defined.

In some implementations, personal news is displayed in a certain physically segmented section of the screen. For example, like a split-channel display that displays two or more channels at once on a television screen, personal news may be displayed on a dedicated portion of a television screen. With a split-channel type of display of personal news it would be possible to continuously provide personal news on the dedicated screen space for personal news. Dedicated screen space may be specified for one or more particular channels or may be selected on-demand by a user. A user may be able to toggle between the different sections of the physical screen to view the content on the full screen for tire toggled section.

In some implementations, personal content items are delivered in a radio segment. Similar to the television platform, segments of radio programs may be replaced with personal news, at certain time slots of existing radio programs. The radio time slots to provide personal news on, may be user-configurable or determined by the system based on usage history of the user. Personal news streams, e.g., social streams, may first be converted to an audio format suitable, for providing content on a radio channel. Where the received news is received in a radio-suitable audio format no conversion may be required.

Personal news delivered during a “you” segment or otherwise may be filtered prior to delivery on a television or radio program or channel. For example, personal content may be filtered by a source (e.g., a member of a social group of a user of the client device presenting the programming content), or by the time of receipt of the personal content items, or by the type of personal content items. Filtering may be done to not overwhelm the personal news segment with voluminous data received from a social stream. Filtering may be done by the system and/or be based on user configurations. Filtering may be based on the type of news, the source of news, the type of content, the data format, of the stream, general interest level of the content, ranking of content, ranking of content based on the presentation format of the content, etc. Examples of filtering are discussed in more details below.

Social streams have been used as example sources of personal news. However, personal news data may be received from any other network data source. For example, other sources may include messaging applications, or any other internet data sources that may be of interest to a user to be consumed using an alternative platform, for example a television or radio device.

A user may receive content on a client device. A client device for receiving personal content for integration with existing programming content should be capable of receiving programming content from content sources, e.g., television and radio content providers (e.g., cable, dish, satellite, broadcast, etc.). The client device should also be capable of receiving personal content data (e.g., via cable, or internet connectivity) and integrating the personal content data within existing programming content. The client device may have the described capabilities integrated within the device or may have the capabilities via one or more external components connected to the device (e.g., a television using a set-top box).

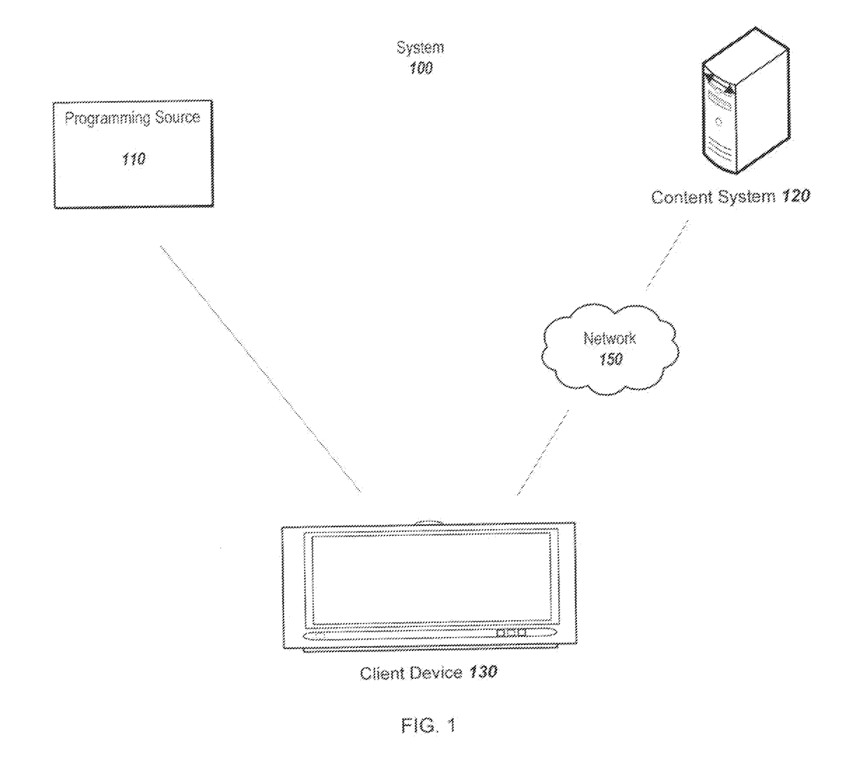

FIG. 1 illustrates a system 100 for integrating social content within existing programming content. The system 100 includes a client device 130, capable of receiving programming content from a programming source 110 and personal content from a content system 120. Client device 130 may, for example, receive television programming content from a television source, e.g., cable, satellite, dish, broadcast, or any other television content provider. Client device 130 is connected to content system 120 via a network 150. The network 150 may include the Internet, a cable network, a Wifi network, an intranet, a local area network, a wide area network, a wired network, a wireless network, a cellular network, or a virtual private network (VPN).

The client device 130 may for example be a computer, laptop, tablet, smart phone, a smart television, a smart radio, or a head and/or eye mounted augmented reality device. The client device 130 may include a browser or another application configured to receive personal content and process personal content (either directly or indirectly via external components) for integration within existing programming content. While only one client device 130 is illustrated in FIG. 1, the subject technology may be implemented in conjunction with one or more client devices 130.

The client device 130 may have a personal content application installed on it, containing modules for receiving and processing personal content streams and displaying at least a portion of the content items on the television screen. The content system 120 may also have a personal content application installed on it, containing modules configured to deliver personal content tor display on the client device 130. A personal content application may have access to various social streams (e.g., by a viewer of the client device 130 providing authorization to access the viewer's social streams). The accessed social streams may be filtered (based on system and/or user preferences), converted to a suitable format (e.g., audio and animation for a television device, or audio format for a radio device, or a text format for a ticker implementation, etc.), and used to replace a designated existing program segment with personal content.

In some implementations, the personal content application is divided into a server portion, installed on content system 120, and a client portion, installed on the client device 130. Workload to integrate social streaming content in existing programming content may be divided between the server and client portions of the personal content application in various ways. For example, the server portion of the personal content application may handle receiving of social streams, filtering of social streams (e.g., by source, time of receiving, type of content, etc.), conversion of data formats (e.g., convert to voice data for animation in a “you” section or text data for ticker display), and delivery of the filtered, converted, social stream to client device 130.

The client portion of the personal content application may take the incoming filtered, converted social stream and di splay it on the screen (perhaps buffering portions of it as required). Also, in the dynamic insertion, of personal content aspect, for example in replacing advertisement segments with personal content items, the client portion of the personal content application may process incoming programming content, received from programming source 110, to determine if advertisement content is coming in and replace it with personal content being received from content system 120. Many variations for dividing the work between a server and a client component for handling personal content for integration in existing programming content can be appreciated without deviating from the scope of this disclosure.

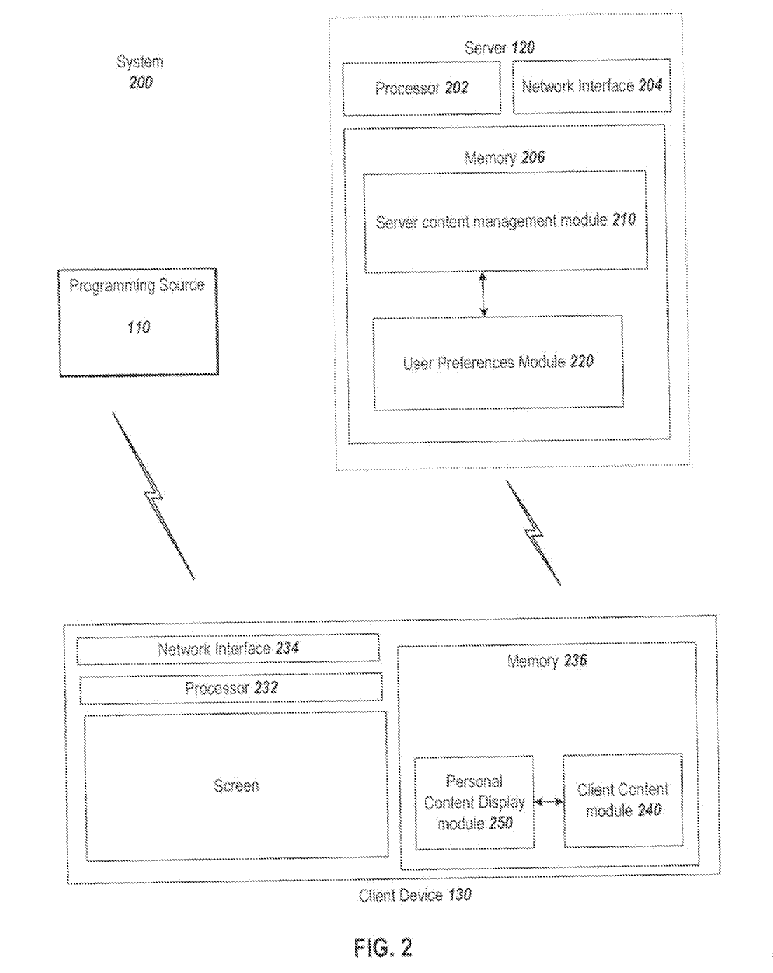

FIG. 2 illustrates an example of the server 120 and client device 130 of FIG. 1 in more detail. As shown, the client device 130 is connected to a programming source 110 and a server 120. Client device 130 receives programming content through its connectivity to programming source 110, and receives personal content through the connectivity with server 120.

As shown, the server 120 includes a processor 202, a network interface 204, and a memory 206. The client device 130 includes a processor 232, a network interface 234, and a memory 236. The processors 202 and 232 are configured to execute computer instructions that are stored in a computer-readable medium, for example, the memory 206 or the memory 236 respectively. The processor 202 or 232 may be a central processing unit (CPU). While only one processor 202 and 232 are illustrated, the server 120 or the client device 130 may include multiple processors. Furthermore, while the server 120 is illustrated as a single machine, the server 120 may include multiple machines, e.g., within a server farm. Also, while the client device 130 is illustrated as a single machine, it may be multiple machines or one machine attached to external components (e.g., a smart television with a set-top box), etc.

The network interface 204 and 234 are configured to allow the server 120 and client device 130 to transmit and receive data in a network, e.g., network 150 of FIG. 1. The network interlace 204 and 234 may include one or more network interface cards (NICs). The memory 206 and 236 may store data or instructions.

As illustrated, server 120's memory 206 includes a server content management module 210 and a user preferences module 220. Client device 130 has a screen for displaying personal content within existing programming content and for user interaction with provided personal content and client device 130's memory 236 has a client content module 240 for processing personal content and a personal content display module 250 for displaying the processed personal content.

The server content management module 210 may be configured to facilitate sending personal content streams to one or more client devices, for example the client device 130. Client device 130's client content module 240 may be configured to receive personal content streams sent to it for display on the client device screen in existing programming segments. Client device 130's personal content display module 250 may communicate with client content module 240 to receive personal content to be displayed on the screen.

Server content management module 210 may buffer personal content for delivery to client device 130. Buffering may be done to either deliver the content as and when the personal content is to be integrated within existing programming or buffering may be done to manage system or client resources. For example, server content management module 210 may buffer content for delivery at a particular time of the day on which personal content is to replace an existing programming segment. In another implementation, server content management module 210 may provide streaming social content as it is received to the client content module 240 for it to be handled, as desired by the client content module 240.

Server content management module 210 may convert personal content items to a suitable presentation format before delivering to client content module 240. For example, personal content items may be converted to a text format for display as a ticker on a portion of the screen. In another case, personal content items may be converted to voice data to be delivered, for example by an animated character on a television screen. The animated character may be provided to client content module 240 with the converted voice data or the animated character information may reside with the client content, module 240 from a previous (e.g., initializing) communication with server content management module 210. Alternatively, the animated character logic may reside on client content module 240 directly without any server side communication.

Server content management module 210 may be configured to filter personal content for delivering to client content module 240. For example, server content management module 210 may filter content by the source of the content (e.g., a particular person, or a member of a particular social group), or by the type of content (e.g., image data or text data or videos, etc.), or by the time the content is received (e.g., received within one hour of time that the content is to be provided, etc.).

Either or both, server content management module 210 and client content module 240 may be configured to communicate with the user preferences module 220 that maintains user preferences. A user of a client device 130 may access the user preferences module 220 via a web interface or other application to manage the user's preferences. The web interface or other application for managing the user's preferences may be accessible from a device other than client device 130 (e.g., any computing device with internet and web browser capabilities, or a desktop, laptop, tablet, smart phone, etc.). The user may login using an account set up for managing personal content system preferences and add, edit or delete preferences.

User preferences module 220 may provide explicit preferences provided by a user for streaming content (e.g., what segments of a program make up a “you” section). A user may provide more generally, either topic areas of interest to the user or topic areas in which the user docs not have interest. The general user interest information, may be used by user preferences module 220 to determine which programming segments are to be replaced, with personal content. User preferences module 220 may be configured to receive programming information (e.g., time slots for programs and segments within programs), which may be used by a user for selecting segments to replace with personal content.

User preferences module 220 may also be configured to maintain, user preferences, for example, the format in which a user desires personal content to be delivered. For example, a user may select a presentation preference of a ticker-like display, voice plus animation, or split-screen type of display for streaming personal content to a smart-television. The user may also select a character which should, be used to animate and deliver personal content items as personal news. A user may provide preferences about how much personal content (e.g., half-an-hour worth of content, what type of content (e.g., only news from family members), or the time the content is received (e.g., only content posted between 5 and 5:30 pm), or other filtering criteria to be used in delivering personal content.

Server content management module 210 may communicate with user preferences module 220 to receive user preferences to make determinations on when and how to deliver personal content. For example, server content, management module 210 may receive the user preference to replace a 5 pm news program's celebrity segment (e.g., that is slotted to be delivered at 5:15 pm) with personal content. Taking this user preference, server content management module 210 may then provide personal content to client content module 240 near 5:15 pm for replacing the celebrity news section on client device 130. The personal content provided near 5:15 pm may cither be personal content streams received at the time or buffered personal content data.

Server content management module 210 may receive a user's preference about the format in which a user wants personal content delivered to the user, such as on the user's client device. For example, a user may want the information delivered in a ticker-like fashion. Server content management module 210 may take the user's preference and convert personal content to text, if required, for delivery in a ticker. As another example, if a user's preference indicates delivering personal content as voice delivered by an animated character, server content management module 210 may convert personal content to voice data and deliver to client content module 240 for animation and presentation on the client device 130's screen.

Server content management module 210 may receive a user's preference about filtering criteria. For example, server content management module 210 may receive information that a user wants personal content received from family members. As such, server content management module 210 may filter incoming personal content data for content posted by a family member of the user before forwarding to client content module 240. Server content management module 210 may filter on any other criteria, for example the time the content is received or the type of content (e.g., take only content in text format for delivery to a client device), or the ranking of the content (e.g., ranking of content based, on presentation format of the personal content to be delivered).

Server content management module 210 may be configured to receive content from various personal content sources, for example, comments, images, videos, etc. posted on social networking platforms or other personal content platforms (e.g., blogs, messaging servers). Personal content may be received by server content management module 210 either directly from the personal content source or indirectly from other server modules or from a database that stores personal content data. As such, server content management module 210 may provide streaming or previously received personal content data to client content module 240 for presentation at the client device 130.

Client content module 240 may share the workload by executing some of functionality described for server content management, module 210. For example, client content module 240 may do the filtering, converting, etc. for received personal content items. Client content module 240 may replace the existing programming content with personal content items or it may provide personal content to the personal content display module 250. Personal content display module 250 may take filtered and converted content and determine whether a currently viewable programming segment should be replaced with personal content. Personal content display module 250 may display on the whole screen or on part of the screen personal content where it has determined that a current segment is to be replaced with personal content items.

The workload for filtering, converting, determining user preferences may be performed by client content module 240 instead of server content management module 210, or it may be in some combination of the two modules. User preferences module 220 may run either on server 120 or on client device 130 or in some combination of the two. The modules provided in FIG. 2 are one example and many other implementations for workload distribution can achieve the described functionality for integrating personal content items in existing programming content, without deviating from the scope of this disclosure.

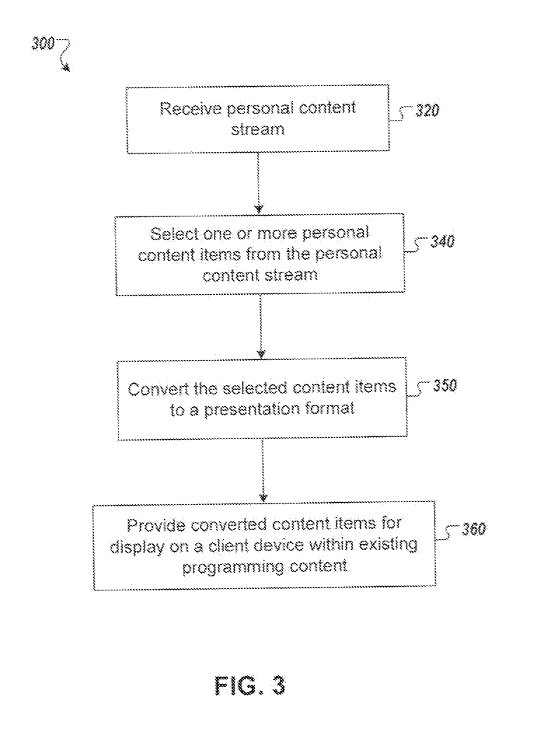

FIG. 3 is a flow chart that shows an example of a process for providing personal content stream data for integration within existing programming content. The process may be performed, for example, by a system 100 or system 200. For clarity of presentation, the description that follows uses the system 100 and system 200 as an example for describing the process. However, another system, or combination of systems, may be used to perform the process.

The process 300 may start when a module is set up for receiving personal content (e.g., when server content management module 210 of FIG. 2 is installed). At step 320, personal content streams' data is received by a computing device (e.g., server 120 or client device 130 of FIG. 2). For example, personal content streams may be received from a social networking platform as comments, images, or other types of data posted on the social networking platform. The received personal content data may be buffered as it is received before further processing of the received data. Buffering may be done to manage incoming data for time of delivery, or for managing system resources, or for waiting for a time when a client device is ready to accept personal content Items for insertion in existing programming, etc. Buffering may be done at one or more of the steps described for process 300.

At step 340, one or more personal content items are selected from the received personal content stream, that may or may not have been buffered or filtered upon receipt. The personal, content items may be selected based on user-preferences (e.g., a user may have asked for pictures of images to be presented in personal content) or based on system processing (e.g., based on past usage history of a user of the client device) or based on general system parameters (e.g., select a certain data size of personal content or a certain timestamp of personal content items to deliver to a client device).

At step 350, personal content streams are converted. In some aspects, the streams are converted from personal or social content stream format to a presentation format. For example, text data may be convened to voice or audio data to be delivered by an animated character as a personal news broadcaster. In some implementations, personal content streams may be received in a format that does not require any conversion. In some implementations, conversion, where required, may be left to a client-side personal content application (e.g., the client content module 240 of FIG. 2). At step 360, personal content, stream data is provided to a client device for inclusion in existing programming. The client device may have a receiving module, for example, client content module 240 of FIG. 2. The client content module 240 may execute one or more of the steps described in FIG. 3. The client content module 240 or personal content display module 250 may display the received, personal content on the screen of the client, device within existing programming content.

The content provided at step 36b may be displayed in a ticker on a portion of the client device's screen. For example, it may be displayed on a bottom portion of the screen. The ticker style presentation of personal content, allows for delivering personal news continuously in the ticker. In some implementations, the received personal content may be displayed in a “you” section defined by the user or determined based on past user behavior. Alternatively, the step 360 content may be provided in a certain portion of the screen, thereby providing both personal news and existing programming content simultaneously in a split-channel type of display. In the split-channel or other simultaneous display types, a user may be allowed to toggle between the two programs being delivered (the personal content and the existing programming content). The receiving client device may take data received from step 360 and do filtering, converting, buffering, discarding, etc. before displaying on the screen.

The displayed personal content may be interactive. For example, a user of the client device 130 may use a remote control or keyboard for the client device to interact with the provided personal content.

Personal content streams received by a computing device (e.g., at step 320) may be filtered. Filtering may be done by the content provider (e.g., content system 120) or by the content receiving device (e.g., client device 130). For example, incoming streams may be filtered by content system 120 for data for particular users who are interested in receiving personal content items at their respective client devices. Content system 120 may also filter content based on the type of content suitable for delivery to a certain client device 130.

Personal content may also be littered based on user preferences (as discussed above in conjunction with user preferences module 220). For example, data may be filtered for members of certain social groups that the user belongs to, or for the type of content foe user has expressed interest in viewing or listening to. Personal content may also be filtered based on system criteria (unrelated to user preferences). For example, personal content may be filtered to provide only the type of data that a particular client device can handle (e.g., a smart radio device may not be able to handle images or videos so such data may be filtered out when personal content is to be delivered to a smart radio). Personal content data may be buffeted prior to filtering or after filtering.

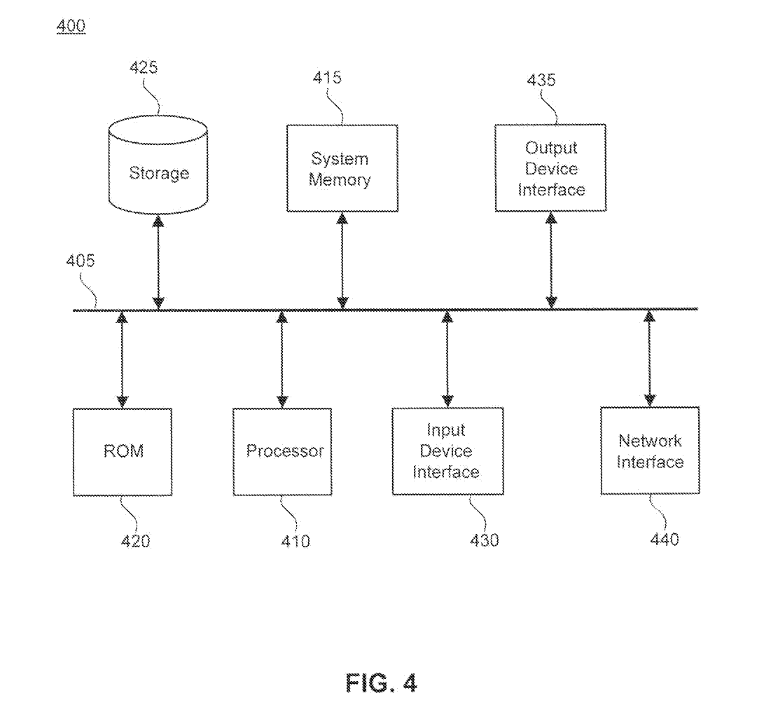

FIG. 4 conceptually illustrates an electronic system 400 with which some implementations of the subject technology are implemented. For example, one or more of the server 120 or the client device 130 of FIG. 1 may be implemented using the arrangement of the electronic system 400. The electronic system 400 can be a computer (e.g., a desktop, server), or any other sort of electronic device (e.g., a client device or smart radio). An electronic device may have the described components integrated within the electronic device, e.g., the client device or smart radio, or may have some or all of the capabilities via connectivity to external components connected to the electronic device.

Such an electronic system includes various types of computer readable media and interfaces for various other types of computer readable media. Electronic system 400 includes a bus 405, processing units(s) 410, a system memory 415, a read-only memory 420, a permanent storage device 425, an input device interlace 430, an output device interface 435, and a network interface 440.

The bus 405 collectively represents all system, peripheral, and chipset buses that communicatively connect the numerous internal devices of the electronic system 400. For instance, the bus 405 communicatively connects the processing unit(s) 410 with the read-only memory 420, the system memory 415, and the permanent storage device 425.

From these various memory units, the processing unit(s) 410 retrieves instructions to execute and data to process in order to execute the processes of the subject technology. The processing unit(s) can be a single processor or a multi-core processor in different implementations.

The read-only memory (ROM) 420 stores static data and instructions that are needed, by the processing unit(s) 410 and other modules of the electronic system. The permanent storage device 425, on the other hand, is a read-and-write memory device. This device is a non-volatile memory unit, that stores instructions and data even when the electronic system 400 is off. Some implementations of the subject technology use a mass-storage device (for example a magnetic or optical disk and its corresponding disk drive) as the permanent storage device 425.

Other implementations use a removable storage device (for example a floppy dish, flash drive, and its corresponding disk drive) as the permanent storage device 425. Like the permanent storage device 425, the system memory 415 is a read-and-write memory device. However, unlike storage device 425, the system memory 415 is a volatile read-and-write memory, such, a random access memory. The system memory 415 stores some of the instructions and data that the processor needs at runtime. In some implementations, the-processes of the subject technology are stored in the system memory 415, the permanent storage device 425, or the read-only memory 420. For example, the various memory units include instructions for providing personal content for integration in existing programming content in accordance with some implementations. From these various memory units, the processing unit(s) 410 retrieves instructions to execute and data to process in order to execute the processes of some implementations.

The bus 405 also connects to the input and output device interfaces 430 and 435. The input device interface 430 enables the user to communicate information and select commands to the electronic system. Input devices used with input device interface 430 include, for example, alphanumeric keyboards and pointing devices (also called “cursor control devices”). Output device interfaces 435 enables, for example, the display of images generated by the electronic system 400. Output devices used with output device interface 435 include, for example, printers and display devices, for example cathode ray tubes (CRT) or liquid crystal displays (LCD). Some implementations include devices for example a touchscreen that functions as both input and output devices.

Finally, as shown in FIG. 4, bus 405 also couples electronic system 400 to a network (not shown) through a network interface 440. In this manner, the electronic system 400 can be a part of a network of computers (for example a local area network (“LAN”), a wide area network (“WAN”), or an Intranet, or a network of networks, for example the Internet. Any or all components of electronic system 400 can be used in conjunction with the subject technology.

The above-described features and applications can be implemented as software processes that are specified, as a set of instructions recorded on a computer readable storage medium (also referred to as computer readable medium). When these instructions are executed by one or more processing units) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include unaware residing in read-only memory or applications stored in magnetic storage or slash, storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program, (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can fee stored in a portion of a file that holds other programs or data (e.g., one or more scripts stored in a markup language document), in a single file dedicated to the program in question, or In multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that, store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with, a user by sending documents to and receiving documents from a device that is used by the user; for example, by sending web pages to a web browser on a user's client device in response to requests received from the web browser.

The subject, matter described in this specification can be implemented in a computing system, that includes a back end component, e.g., as a data server, or that includes a middleware component e.g., an application server, or that includes a front end component, e.g., a client computer having a graphical user interface or a Web browser through which a user can interact with an implementation of the subject matter described in this specification, or any combination, of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input horn a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that, all illustrated steps be performed. Some of the steps may be performed simultaneously. For example, in certain, circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration, is essential to the subject technology or that such configuration applies to all configurations of the subject technology. A disclosure relating to a configuration may apply to all configurations, or one or more configurations. A phrase, for example, a configuration may refer to one or more configurations and vice versa.

1. A computer-implemented method comprising:
selecting a content item from a personal content
stream;
buffering, at a server, the selected content item for delivery at a particular time, wherein the buffering facilitates management of computing resources of the server configured to deliver content items for display on a client device;
converting the buffered selected content item from a stream format into a presentation format;
determining a particular user preference related to a particular type of content for replacing a portion of existing programming content starting at the particular time;
integrating the converted buffered selected content item within the portion of existing programming content when the converted buffered selected content item matches the particular type of content; and
sending, by the server to the client device, the integrated converted buffered selected content item for presentation, at the client device, within the portion of existing programming content at the particular time.

2. (canceled)

3. The method of claim 1, further comprising: selecting content items from the personal content stream;
filtering the selected content items by a source of the selected content items.

4. The method of claim 1, further comprising:
selecting content items from the personal content stream;
filtering the selected content items by a time of receipt of the selected content items.

5. The method of claim 1, further comprising:
selecting content items from the personal content stream;
filtering the selected content items by a type of the selected content items.

6. The method of claim 1, wherein the personal content stream is a social networking stream.

7. The method of claim 1, wherein the integrated converted buffered selected content are item is user interactive.

8. The method of claim 1, wherein at least a portion of the buffered selected content item are converted to an image format for presentation within existing programming content on a screen.

9. The method of claim 1, wherein at least a portion of the buffered selected content item are converted to a video format for presentation within existing programming content on a screen.

10. The method of claim 1, wherein at least a portion of the buffered selected content item are converted to a text format for presentation on a portion of a screen.

11. The method of claim 1, wherein at least a portion of the buffered selected content item are converted to an audio format for presentation.

12. The method of claim 11, wherein converting the buffered selected content item comprises adding an animation to recite the at least the portion of the buffered selected content item converted to the audio format, for presentation within existing content on a screen.

13. A computer-readable medium storing instructions that when executed cause a computer to perform operations, the operations comprising:
receiving social content items;
buffering, at a server, a social content item of the social content items for delivery at a particular time, wherein the buffering facilitates management of computing resources of the server configured to deliver content items for display on a client device;
converting the buffered social content item from a presentation format particular to an existing programming content format;
determining a particular user preference related to a particular type of content for replacing a portion of existing programming content starting at the particular time;
integrating the converted buffered content item within the portion of existing programming content when the converted buffered content item matches the particular type of content; and
sending, by the server to the client device, the integrated converted buffered content item for presentation, at the client device, within the portion of existing programming content at the particular time.

14. (canceled)

15. The computer-readable medium of claim 13, further comprising:
filtering the received social content items by a source of the received social content items.

16. The computer-readable medium of claim 13, further comprising:
filtering the received social content items by a time of receipt of the received social content items.

17. The computer-readable medium of claim 13, further comprising:
filtering the received social content items by a type of the received social content items.

18. The computer-readable medium of claim 13, wherein the integrated converted buffered social content item is user interactive.

19. The computer-readable medium of claim 13, wherein at least a portion of the received social content items are converted to an image format for presentation within existing programming content on a screen.

20. The computer-readable medium of claim 13, wherein at least a portion of the received social content items are converted to a video format for presentation within existing programming content on a screen.

21. The computer-readable medium of claim 13, wherein at least a portion of the received social content items are converted to a text format for presentation on a portion of a screen.

22. The computer-readable medium of claim 13, wherein at least a portion of the received social content items are converted to an audio format for presentation.

23. A computer-implemented system, the system comprising:
one or more processors;
a memory comprising instructions which, when executed by the one or more processors, cause the one or more processors to:
receive social content items for integration within an existing program;
buffer, at a server, a social content item of the social content items for delivery at a particular time, wherein the buffering facilitates management of computing resources of the server configured to deliver content items for display on a client device;
determine a particular user preference related to a particular type of content for replacing a portion of existing programming content starting at the particular time;
integrate the buffered content item within the portion of existing programming content when the buffered content item matches the particular type of content; and
send, by the server to the client device, the integrated buffered content item for presentation, at the client device, within the portion of existing programming content at the particular time.

24. The computer-implemented system of claim 23, wherein the instructions further cause the one or more processors to convert at least one of the received social content items from a received format to a presentation format.

25. The computer-implemented system of claim 23, wherein
determine a current time slot for the existing program viewable by a user;
determine if the current time slot is the time flagged for personal content is based on a user preference.

26. The computer-implemented system of claim 23, wherein determining if a current time slot is the time flagged for personal content is based on analysis of the user's past usage history.

27. (canceled)

28. The computer-implemented system of claim 23, wherein the instructions further cause the one or more processors to:
filter the received social content items by a source of the received social content items.

29. The computer-implemented system of claim 23, wherein the instructions further cause the one or more processors to:
filter the received social content items by a time of receipt of the received social content items.

30. The computer-implemented system of claim 23, wherein the instructions further cause the one or more processors to:
filter the received social content items by a type of the received social content items.

31. The computer-implemented system of claim 23, wherein the integrated buffered social content item is user interactive.

32. The computer-implemented system of claim 23, wherein at least a portion of the received social content items are converted to an image format for presentation within existing programming content on a screen.

33. The computer-implemented system of claim 23, wherein at least a portion of the received social content items are converted to a video format for presentation within existing programming content on a screen.

34. The computer-implemented system of claim 23, wherein at least a portion of the received social content items are converted to a text format for presentation on a portion of a screen.

35. The computer-implemented system of claim 23, wherein at least a portion of the received social content items are converted to an audio format for presentation.
